(19) United States
(12) Patent Application Publication
(10) Pub. No.: US 2022/0079113 A1
(43) Pub. Date: Mar. 17, 2022

(54) ANIMAL FEEDER FOR HAY

(71) Applicant: Western Pro Feeders, LLC, Oklahoma City, OK (US)

(72) Inventor: Glen Leslie McAlister, Savery, WY (US)

(73) Assignee: Western Pro Feeders, LLC, Oklahoma City, OK (US)

(21) Appl. No.: 17/474,040

(22) Filed: Sep. 13, 2021

Related U.S. Application Data
(60) Provisional application No. 63/076,940, filed on Sep. 11, 2020.

(51) Int. Cl. A01K 5/01; A01F 15/10; A01K 1/10

(52) U.S. Cl. CPC A01K 5/01; A01K 1/10; A01F 15/10

(57) ABSTRACT

This invention relates to a feeder for feeding hay bales to animals. The inventive animal feeder includes a feeder base, a feeder cone and a tray. The feeder cone is mounted above the base for receiving and holding the hay to be fed to animals. In one embodiment, the feeder cone has three inwardly sloping cone side assemblies and an inwardly sloping shortened cone side assembly to facilitate loading hay into the feeder cone. A tray is supported by the base and positioned below the feeder cone to catch hay that falls as animals are feeding from the feeder cone, preventing waste and exposure to parasite and other contaminants. In an alternative embodiment, all four sides of the feeder cone 12 are constructed the same, with no shortened side.

### CROSS-REFERENCE TO RELATED APPLICATIONS

This application claims the benefit of U.S. provisional application No. 63/076,940 entitled “Improved Hay Feeder,” filed Sep. 11, 2020, the contents of which are incorporated herein by reference.

### BACKGROUND OF THE INVENTION

### Field of the Invention

The present invention relates to feeders for animals, including livestock, and more particularly, but not by way of limitation, to an improved livestock feeder for hay bales.

### Discussion of the Prior Art

Hay bales are commonly used to feed livestock. In the past, these bales were typically fed to cattle by either scattering the bales on the ground around the pasture or by setting them in a single place. However, these methods of feeding the bales to cattle resulted in significant amounts of hay being wasted or ruined through contact with the ground. When hay contacts the ground, it can result in contamination from manure and ground parasites.

In the 1970's, the hay ring was invented to help address these problems. Since then, various types of hay feeders have been developed, but all of these prior art feeders suffer from various drawbacks or problems. For instance, many prior art feeders employ V-shaped geometries that create dangerous catch points which can result in livestock getting their heads or necks caught in the feeder. The present invention is designed to address the problems with prior art feeders.

### BRIEF DESCRIPTION OF THE DRAWINGS

The accompanying drawings, which are incorporated into and form a part of the specification, illustrate one or more embodiments of the present invention and, together with this description, serve to explain the principles of the invention. The drawings merely illustrate preferred embodiments of the invention and are not to be construed as limiting the scope of the invention.

FIG. 1 is a front perspective view of animal feeder constructed in accordance with a preferred embodiment of the present invention.

FIG. 2 is a side perspective view of an animal feeder constructed in accordance with a preferred embodiment of the present invention.

FIG. 3 is bottom perspective view of the feeder base of an animal feeder constructed in accordance with a preferred embodiment of the present invention.

FIG. 4 is a detailed perspective view of a safety bar and bracket constructed in accordance with a preferred embodiment of the present invention.

FIG. 5 is a top perspective view of a tray constructed in accordance with a preferred embodiment of the present invention.

FIG. 6. Is a perspective view of an animal feeder loaded with a round bale of hay which has been constructed in accordance with a preferred embodiment of the present invention.

### DETAILED DESCRIPTION OF THE PREFERRED EMBODIMENT

Reference is made herein to the attached drawings. Like reference numerals are used throughout the drawings to depict like or similar elements of the present invention. For the purposes of presenting a brief and clear description of the present invention, the preferred embodiment will be discussed as used for feeding livestock. This embodiment is exemplary only. Other embodiments and variations will become apparent to those skilled in the art upon study of the specification and drawings of this application.

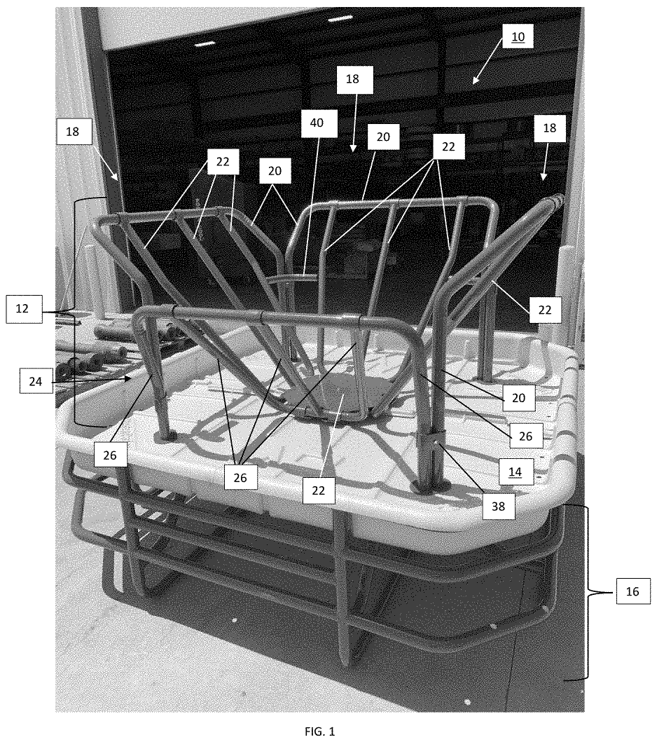

The animal feeder 10 of the present invention is used to safely and efficiently distribute nutrients in various forms including (but not limited to) round bales, big square sales, (industry defines this to also include rectangular bales), small square bales, grain and pellets. As shown in FIG. 1, the animal feeder 10 has three primary sections: (a) the feeder cone 12 which holds the hay and controls how the hay is dispensed to the animals, (b) the tray 14 which keeps the hay off the ground and catches all the loose hay as the animals feed, (c) and the feeder base 16 which supports the entire animal feeder 10.

On three sides, the feeder cone 12 is built from inwardly sloping cone side assemblies 18, which include cone side supports 20 and cone side members 22. As shown, the cone side members 22 are attached at their upper ends to a horizontal section of the cone side supports 20. On a fourth side, the feeder cone 12 is built from an inwardly sloping shortened cone side assembly 24, which includes a shortened cone side support 26 and shortened cone side members 28. The shortened cone side members 28 are attached at their upper ends to a horizontal section of the cone side support 26. The shortened cone side assembly 24 allows for feed to be conveniently loaded into the feeder cone 12 using commonly available farm equipment. The cone side supports 20 and the shortened cone side support 26 are attached through tray 14 to the feeder base 16. The cone side members 22 and shortened cone side members 28 are all attached together at their lower ends to a cone joining assembly 30, which may include upper and lower cone jointing plates. This creates the conically shaped feeder cone 12. This feeder cone 12 is shaped to limit how quickly the animals can consume the feed contained within. Although the terms “cone” and “conically shaped” are used herein, they should be understood to encompass various geometrical configurations that are wider at the top and narrower at the bottom, including without limitation an inverted, truncated pyramidal shape. In an alternative embodiment, all four sides of the feeder cone 12 are constructed the same, with no shortened side.

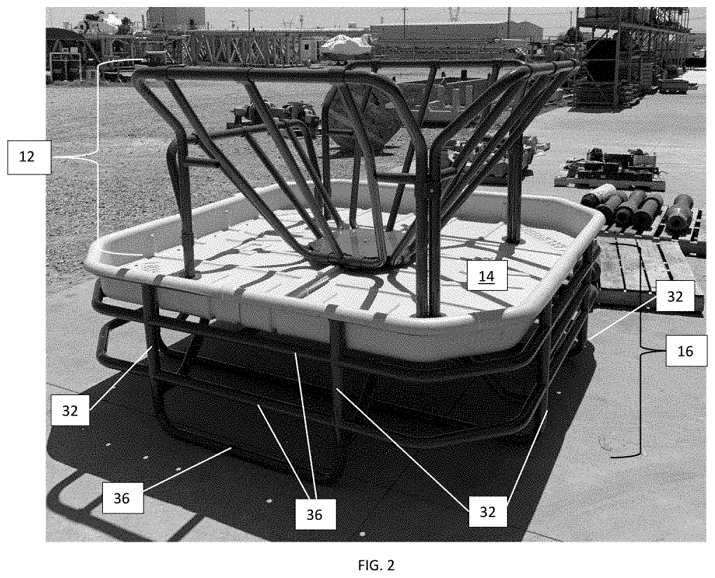

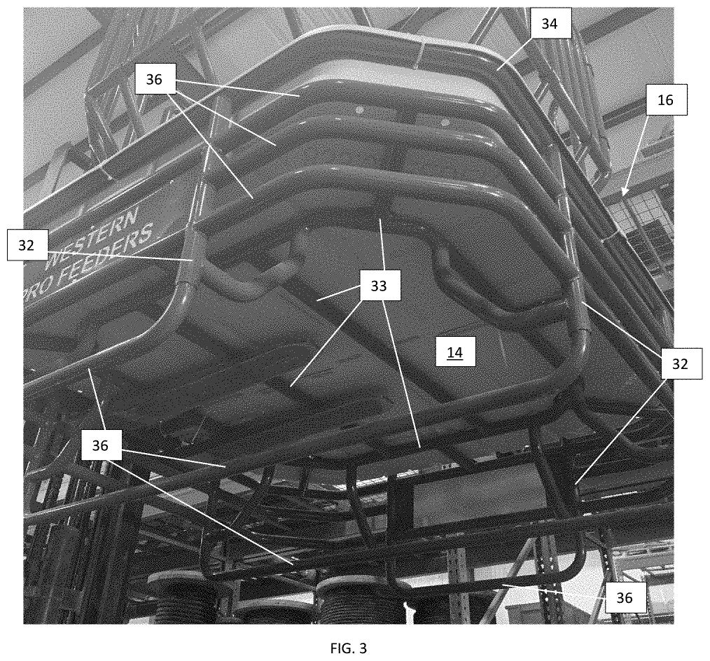

As shown in FIGS. 2-3, under the feeder cone 12 is the feeder base 16. The feeder base 16 has a generally square shape with eight base legs 32 protruding downward, horizontal tray supports 33 and a raised base top rail 34. The legs 32 may be interconnected by skis 36 for ease of moving the animal feeder 10. In this manner, the animal feeder 10 can be built so that it can be moved with or without hay in it by dragging it with a piece of equipment.

Tray 14 is supported on the feeder base 14 and serves to catch any animal feed that falls through the feeder cone 12 or is dropped by the animals as they are feeding. As shown in FIG. 5, the tray 14 is made of two halves 14a, 14b which, when both are slightly tilted upwards, can be slid together and locked into place. The tray 14 is preferably made of high-density thermoplastic which is vacuum formed to final dimensions. In one embodiment, the tray 14 is roughly 7.5′×7.5′×8″, and the feeder base 16 is about 7.5′×7.5′.

In one embodiment, the feeder base 16 has horizontal bars 36 that surround the bottom, perimeter of the animal feeder 10 to enclose the feeder base 16, preventing animals from venturing under the animal feeder 10. The horizontal bars 36 can be configured in such a manner as to provide a convenient space for equipment, such as a forklift, to lift the animal feeder 10 so that it can be moved to a new location, as opposed to dragging it. Although various aspects of the present invention are depicted in the drawings as being constructed from round tubing, persons skilled in the art will recognize that it is also possible to use other structural shapes to achieve the same or similar results. However, round, bent pipe has the advantage that it eliminates sharp edges from “cut-and-weld” corners and joints. In one embodiment, the feeder is made from 1.900″ OD Pipe with 0.095″ wall thickness, 1.660″ OD Pipe with 0.095 wall thickness, and ½″×13-15 flattened expanded metal, and 16 ga sheet metal.

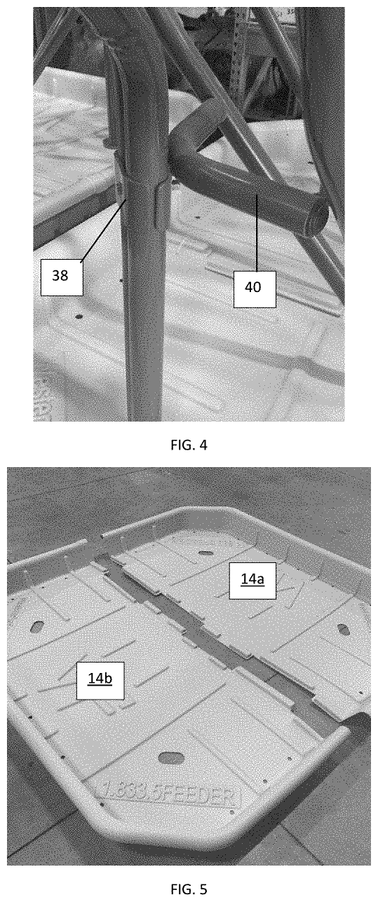

As best shown in FIGS. 1 and 4, the animal feeder 10 may optionally include brackets 38 to hold the cone side supports 20 and shortened cone side support 26 together. Certain of these brackets may also include safety bars 40 which serve to prevent animals from getting their heads or necks wedged into gaps while feeding.

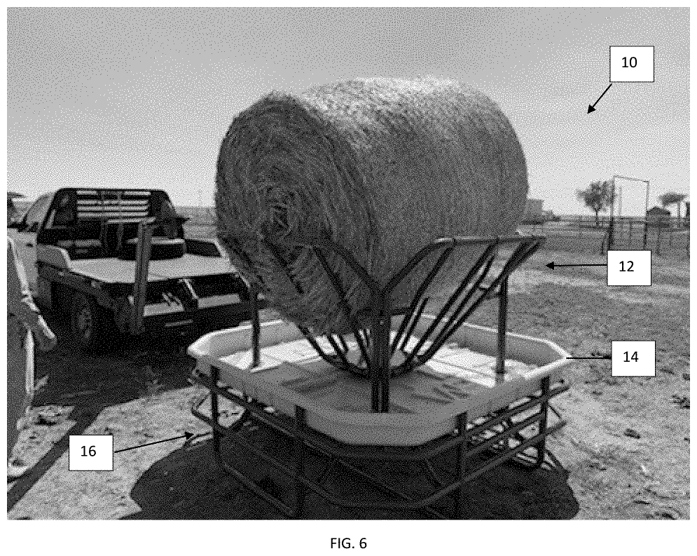

Turning now to FIG. 6, the animal feeder 10 is used by delivering the animal feeder to the desired location for feeding. The animal feeder 10 can be moved to the location by simply connecting a chain around the base of the feeder and pulling in the direction of the incorporated skis 36 attached to the base legs 32 with any piece of power equipment. Alternatively, the animal feeder can be lifted with a forklift and carried to the desired location. Hay is loaded into the feeder cone 12 by placing it over the shortened cone side assembly 24. Hay moves down the feeder cone by means of gravity. As the animals come to feed, they reach their head over the outermost part of the tray 14 and eat the plant material by putting their mouths through the bars of the feeder cone 12. The four-sided nature of the animal feeder 10 allows animals to feed from all four sides. Due to the wedge shape of the feeder cone 12, the hay will be slightly compacted as it moves downwardly, making it more difficult for the animals to take large bites of hay. This ensures they will take exactly the amount of hay in each bite that they will actually consume. This reduces waste immensely and allows up to 97% efficiencies. As the animals deplete the supply of hay in the cone, more hay is loaded into feeder cone 12.

The tray 14, positioned directly under where the hay bale is loaded into the feeder cone 12, catches virtually all hay that is dropped from livestock's mouths, keeping the hay off the ground. While feeding, livestock will follow the path of least resistance, so they will eat the most easily accessible hay first. The most accessible hay is the hay lying in the tray 14, which will get consumed before the livestock continue to pull new hay from the hay bale. By forcing the livestock to feed from within the feeder cone 12, the livestock are forced to eat more slowly, thus greatly reducing waste and feeding-based medical conditions.

While the invention has been particularly shown, described and illustrated in detail with reference to the preferred embodiment, it should be understood by those skilled in the art that various changes in form and detail may be made therein without departing from the true spirit and scope of the invention, except as precluded by the prior art. The scope of the invention is to be determined by the claims. It is intended that the claims are interpreted to include all such variations, modifications, additions, subtractions, permutations, and sub-combinations as are within their true spirit and scope, including those which may be recognized later by those skilled in the art.

1. An animal feeder for feeding hay comprising:
a feeder base;
a feeder cone mounted above the base for receiving and holding hay to be fed to animals, wherein the feeder cone has three inwardly sloping cone side assemblies and an inwardly sloping shortened cone side assembly to facilitate loading hay into the feeder cone; and
a tray supported by the base and positioned below the feeder cone to catch hay that falls as animals are feeding.

2. The animal feeder of claim 1 wherein each of the three inwardly sloping cone side assemblies comprises:
a cone side support having a horizontal portion, wherein the cone side support passes through the tray and attaches to the feeder base; and
a plurality of cone side members having upper and lower ends and that each attach at the upper end to the horizontal portion of the cone side support.

3. The animal feeder of claim 2 wherein the inwardly sloping shortened cone side assembly comprises:
a shortened cone side support having a horizontal portion, wherein the shortened cone side support passes through the tray and attaches to the feeder base; and
a plurality of shortened cone side members having upper and lower ends and that each attach at the upper end to the horizontal portion of the shortened cone side support.

4. The animal feeder of claim 3 further comprising a cone joining assembly to secure the cone side members and shortened cone side members at their lower ends.

5. The animal feeder of claim 4 wherein the feeder base comprises a plurality of base legs.

6. The animal feeder of claim 5 wherein a plurality of the base legs are interconnected to form skis for facilitating movement of the animal feeder.

7. The animal feeder of claim 6 wherein the feeder base comprises horizontal bars around the perimeter to enclose the feeder base.

8. The animal feeder of claim 7 further comprising safety bars attached to the feeder cone to prevent animals from getting their heads or necks wedged in the feeder cone while feeding.

9. An animal feeder for feeding hay comprising:
a feeder base;
a feeder cone mounted above the base for receiving and holding hay to be fed to animals, which comprises:
a plurality of inwardly sloping cone side assemblies which form the uppermost part of the animal feeder; and
a tray supported by the base and positioned below the feeder cone to catch hay that falls as animals are feeding.

10. The animal feeder of claim 9 wherein each of the inwardly sloping cone side assemblies comprises:
a cone side support having a horizontal portion, wherein the cone side support passes through the tray and attaches to the feeder base; and
a plurality of cone side members having upper and lower ends and that each attach at the upper end to the horizontal portion of the cone side support.

11. The animal feeder of claim 10 further comprising:
a shortened cone side support having a horizontal portion, wherein the shortened cone side support passes through the tray and attaches to the feeder base; and
a plurality of shortened cone side members having upper and lower ends and that each attach at the upper end to the horizontal portion of the shortened cone side support.

12. The animal feeder of claim 11 further comprising a cone joining assembly to secure the cone side members and shortened cone side members at their lower ends.

13. The animal feeder of claim 12 wherein the feeder base comprises a plurality of base legs.

14. The animal feeder of claim 13 wherein a plurality of the base legs are interconnected to form skis for facilitating movement of the animal feeder.

15. The animal feeder of claim 12 wherein the feeder base comprises horizontal bars around the perimeter to enclose the feeder base.

16. The animal feeder of claim 12 further comprising safety bars attached to the feeder cone to prevent animals from getting their heads or necks wedged in the feeder cone while feeding.
